(19) United States
(12) Patent Application Publication
(10) Pub. No.: US 2025/0074145 A1
(43) Pub. Date: Mar. 6, 2025

(54) PERSONALIZING CLIMATE CONDITIONS IN A VEHICLE

(71) Applicant: Rivian IP Holdings, LLC, Irvine, CA (US)

(72) Inventors: Paulo Lucena Kreppel PAES, Irvine, CA (US); Ajay PANEKKAD, Laguna Niguel, CA (US); Dewashish PRASHAD, Irvine, CA (US)

(21) Appl. No.: 18/458,041

(22) Filed: Aug. 29, 2023

(51) Int. Cl. B60H 1/00

(52) U.S. Cl. CPC B60H 1/00742; B60H 1/0075; B60H 1/00785; B60H 1/00835

(57) ABSTRACT

In certain embodiments, a method of personalizing climate conditions in a vehicle includes determining, by a vehicle control system, a physiological status of an occupant of the vehicle. The method also includes determining, by the vehicle control system, a climate control response based on the physiological status of the occupant. The method also includes controlling at least one climate control device in relation to an interior of the vehicle based on the climate control response.

### INTRODUCTION

The present disclosure relates to dynamic climate control, and more particularly, but not by way of limitation, to personalizing climate conditions in a vehicle.

### SUMMARY

In certain embodiments, one general aspect includes a method of personalizing climate conditions in a vehicle. The method includes determining, by a vehicle control system, a physiological status of an occupant of the vehicle. The method also includes determining, by the vehicle control system, a climate control response based on the physiological status of the occupant. The method also includes controlling at least one climate control device in relation to an interior of the vehicle based on the climate control response.

In certain embodiments, another general aspect includes a system for personalizing climate conditions in a vehicle. The system includes at least one climate control device and a vehicle control system communicably coupled to the at least one climate control device. The vehicle control system is operable to determine a physiological status of an occupant of the vehicle. The vehicle control system is also operable to determine a climate control response based on the physiological status of the occupant. The vehicle control system is also operable to control the at least one climate control device in relation to an interior of the vehicle based on the climate control response.

### BRIEF DESCRIPTION OF THE DRAWINGS

FIG. 1 illustrates an example of a vehicle, in accordance with certain embodiments of the present disclosure.

FIG. 2 illustrates a block diagram of an example cabin system, in accordance with certain embodiments of the present disclosure.

FIG. 3 illustrates a block diagram of example components of a vehicle, in accordance with certain embodiments of the present disclosure.

FIG. 4A illustrates example inputs and outputs for a control system in relation to a vehicle interior.

FIG. 4B illustrates an example of an operational flow for personalizing climate conditions, in accordance with certain embodiments of the present disclosure

FIG. 5 illustrates an example of a process for personalizing climate conditions in a vehicle, in accordance with certain embodiments of the present disclosure.

FIG. 6 illustrates an example of a process for determining a climate control response, in accordance with certain embodiments of the present disclosure.

### DETAILED DESCRIPTION

Nowadays, heating, ventilation, and air conditioning (HVAC) systems include smarter (e.g., more sensors, adjustability, and/or response), more dynamic, and more integrated vehicle systems, which may be associated with a greater need for accurate estimations and optimal control strategies to efficiently actuate the system towards optimal thermal comfort. A challenge, however, is accommodating the wide range of conditions found by distinct body types and activity levels using readily available vehicle signals. For example, someone who has just completed a 1-hour run may have a different idea of thermal comfort than someone who has been sedentary the previous hour.

The present disclosure describes examples of methods and systems for personalizing climate conditions in a vehicle based on a physiological status of an occupant of the vehicle. In various embodiments, a system for smart climate control can determine the physiological status based on data provided by one or more of a user device (e.g., a smartphone, smartwatch, fitness tracker, etc.), a network service (e.g., a cloud service communicably accessible to the vehicle and/or one of the foregoing user devices), a vehicle sensor, or the like.

The physiological status can be, or include, a biometric such as heart rate or body temperature, an identification of a recently completed activity such as running or swimming, and/or other information related to the occupant's physical or biological needs related to thermal comfort. The system can determine a climate control response based on the occupant's physiological status, and then control a climate control device for an interior of the vehicle based on the climate control response. In various embodiments, the climate control response may be, for example, an airflow rate, a discharge or vent air temperature, a compressor speed, an air system duct door position, a vent position, a setting for a climate-controlled surface (e.g., a heated surface), and/or the like. Examples will be described relative to the Drawings.

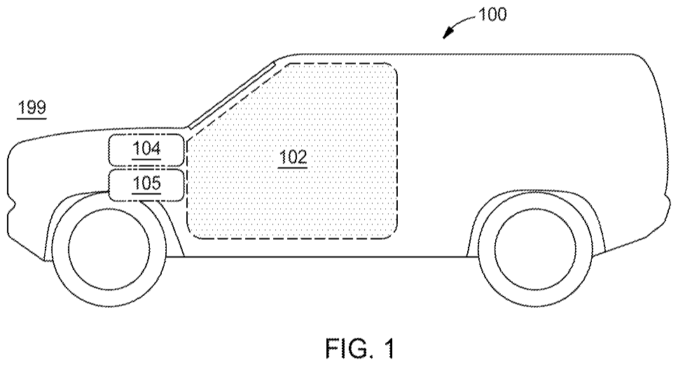

FIG. 1 shows a side view of illustrative vehicle 100 having control system 104 (e.g., for controlling cabin system 105), in accordance with some embodiments of the present disclosure. As illustrated, vehicle 100 includes vehicle interior 102 (also referred to herein as a “cabin”) that includes an interior volume of vehicle 100 and may, for example, correspond to an occupant compartment. It should be appreciated, however, that vehicle interior 102 as shown in FIG. 1 is merely illustrative and that vehicle interior 102 can be larger, smaller, or otherwise defined differently. For example, in various implementations, vehicle interior 102 correspond to an entire inside portion of vehicle 100 or any subdivision thereof. In the example of FIG. 1, vehicle 100 includes control system 104 that is configured to control various vehicle components and systems, including cabin system 105. Cabin system 105 can include, for example, a blower, a refrigeration cycle (e.g., having a compressor, evaporator, condenser, and throttle valve), duct doors (e.g., actuatable duct doors), a heater (e.g., an ohmic heater configured to generate heat based on current flow and a resistive element), any other suitable climate control device, or any combination thereof.

Still with reference to FIG. 1, in an illustrative example, a user or occupant may be located in vehicle interior 102 (e.g., in a seat) and may set a desired temperature. Control system 104 may receive the desired temperature and determine a response based on a physiological status of the occupant, an estimated temperature (e.g., a breath temperature) in vehicle interior 102, environmental conditions 199 (e.g., temperature, pressure, humidity, precipitation), any other suitable information, or any combination thereof. In response, control system 104 may adjust or otherwise control the blower, refrigeration cycle (e.g., a compressor thereof), duct doors (e.g., via an actuator), a heater (e.g., by controlling current flow), climate-controlled surfaces (e.g., seat or steering wheel), any other suitable climate control device, or any combination thereof.

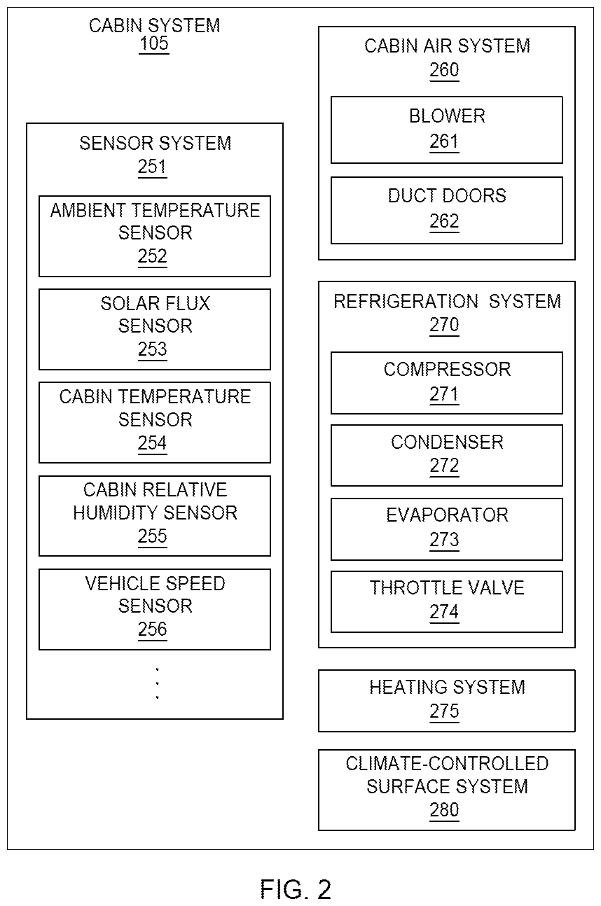

FIG. 2 illustrates cabin system 105 of vehicle 100, in accordance with certain embodiments of the present disclosure. In general, cabin system 105 is configured to provide occupant comfort, interior environment control, or otherwise affect climate conditions in vehicle interior 102. As illustrated, cabin system 105 includes sensor system 251 (e.g., including one or more sensors and/or a sensor interface) and climate control devices configured to affect climate conditions in vehicle interior 102, such as cabin air system 260, refrigeration system 270, heating system 275, and climate-controlled surfaces system 280.

Sensor system 251 can include a plurality of sensors such as an ambient temperature sensor 252 (e.g., a thermocouple, thermistor, resistance temperature detector (RTD), or other sensor on a windshield or location outside vehicle interior 102), a solar flux sensor 253 (e.g., an irradiance sensor such as an absorption sensor), a cabin temperature sensor 254 (e.g., a thermocouple, thermistor, or other sensor in vehicle interior 102), a cabin relative humidity sensor 255 (e.g., an electrochemical sensor, or otherwise a sensor based on resistance, capacitance, or temperature, located in vehicle interior 102), a vehicle speed sensor 256 (e.g., an encoder on a motor shaft or drive shaft), any other suitable sensor, or any combination thereof.

Cabin air system 260 is configured to pressurize and direct airflow to the cabin (i.e., vehicle interior 102) and includes blower 261 and one or more duct doors 262. Blower 261 may include an electric motor and a fan and may be configured to cause air to flow through cabin air system 260, directed by one or more duct doors 262 to regions of the cabin, dash, floor, windshield, console, or a combination thereof. For example, control system 104 may generate control signals for controlling a motor of blower 261 (e.g., controlling a motor speed, current, PWM duty cycle, or other suitable parameter), a position of one or more duct doors 262 (e.g., controlling an actuator position, current, or voltage), any other suitable device, or any combination thereof. In a further example, one or more duct doors 262 may be configured to direct or restrict airflow through evaporator 273 of refrigeration system 270 to cool air, dry the air, or both based on a control signal.

Refrigeration system 270 may include a compressor 271 (e.g., including an electric motor and compressor assembly), a condenser 272, an evaporator 273, and a throttle valve 274, along with any other suitable components, sensors, and plumbing. Refrigeration system 270 may be configured to operate using a refrigerant as a working fluid to achieve sub-ambient temperatures for cooling and/or drying air provided by blower 261. Heating system 275 may include one or more ohmic heaters or other suitable heating devices (e.g., heat recovery devices including heat exchangers) for transferring heat to air provided by cabin air system 260. For example, refrigeration system 270 and heating system 275 may be used to provide air at temperatures above or below ambient temperatures (e.g., and at suitable flow rates and heating/cooling rates to provide defogging, comfort, or both). Climate-controlled surfaces system 280 may include devices and systems to configurably heat or cool selected interior surfaces, such as a steering wheel, seats, armrests, or the like.

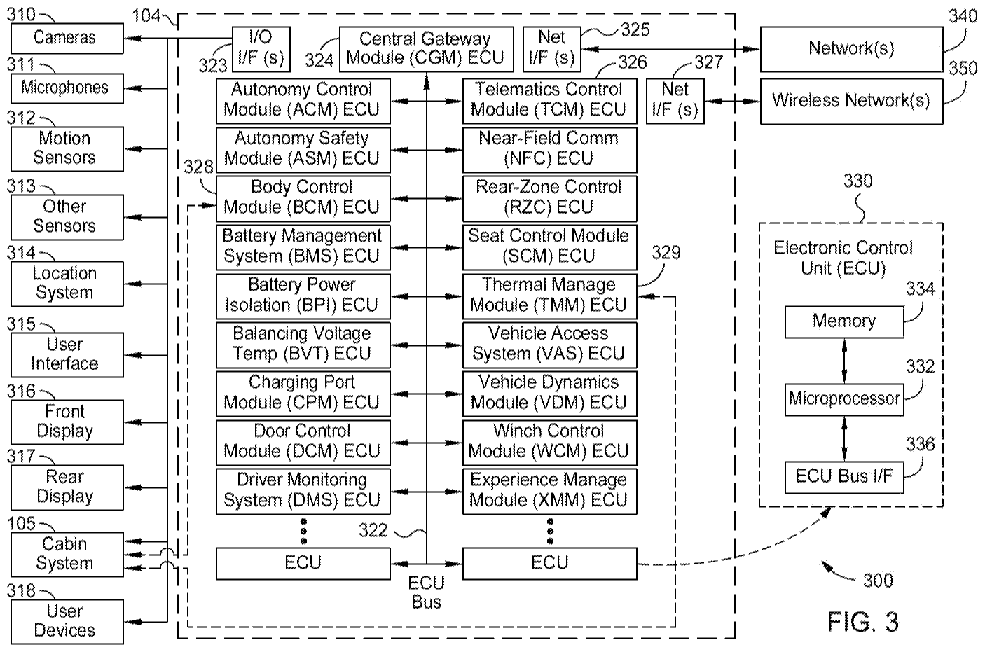

FIG. 3 illustrates a block diagram 300 of example components of vehicle 100, in accordance with certain embodiments of the present disclosure. As described relative to FIG. 1, vehicle 100 includes control system 104, where control system 104 is configured to perform the functions described relative to FIG. 1, as well as other functions for operation of vehicle 100. In many embodiments, control system 104 includes a number of electronic control units (ECUs) 330 coupled to ECU Bus 322. Each ECU 330 performs a particular set of functions, and includes, inter alia, microprocessor 332 coupled to memory 334 and ECU Bus I/F 336. In certain embodiments, control system 104 may include one or more system-on-chips (SOCs). Each SOC may include a number of multi-core processors coupled to a high-speed interconnect and on-chip memory, and may perform a much larger set of functions than a single ECU 330.

Control system 104 is coupled to sensors, input/output (I/O) devices and actuators, as well as other components within a propulsion system, an energy storage system, and/or an accessory system. The sensors may include, for example, cameras 310, microphones 311, motion sensors 312, other sensors 313, location system 314, etc. Location system 314, for example, may be used to determine a location of vehicle 100. For example, in some embodiments, the location system 314 may include global positioning system (“GPS”) and/or geolocation circuitry that can automatically discern the location based on relative positions to multiple GPS satellites or other signal sources, such as cellphone towers or other signal sources. The I/O devices may include, for example, user interface 315, front display 316, rear display 317, user devices 318, sensors of cabin system 105 (e.g., sensor system 251), etc. The actuators may include, for example, actuators of cabin system 105 (e.g., components of cabin air system 260, refrigeration system 270, heating system 275, and/or climate-controlled surfaces system 280). Additionally, control system 104 may be coupled to network(s) 340, network(s) 350, etc.

In certain embodiments, one or more ECUs 330 may include the necessary interfaces to be coupled directly to particular sensors, I/O devices, actuators and other vehicle system components. For example, body control module (BCM) ECU 328 and thermal management model (TMM) ECU 329 may be directly connected to cabin system 105, as indicated by the dashed arrows in FIG. 3.

In many embodiments, control system 104 includes Central Gateway Module (CGM) ECU 324 which provides a central communications hub for vehicle 100. CGM ECU 324 includes (or is coupled to) I/O interfaces 323 to receive data, send commands, etc., to and from the sensors, I/O devices, actuators and other vehicle system components. CGM ECU 324 also includes (or is coupled to) network interface(s) 325 that provides network connectivity through Controller Area Network (CAN) ports, Local Interconnect Network (LIN) ports, Ethernet ports, etc.

For example, CGM ECU 324 may receive data from cameras 310, microphones 311, motion sensor 312, other sensors 313 and location system 314, as well as user interface 315, and then communicate the data over ECU Bus 322 to the appropriate ECU 330. Similarly, CGM ECU 324 may receive commands and data from the ECUs 330 and send them to the appropriate I/O devices, actuators and vehicle components. For example, a GUI widget may be sent to user interface 315 (e.g., a touchscreen front display 316, rear display 317, and/or user devices 318), video data from cameras 310 may be sent to front display 316, rear display 317, user devices 318, etc.

In many embodiments, control system 104 includes Telematics Control Module (TCM) ECU 326 which provides a vehicle communication gateway for vehicle 100. TCM ECU 326 includes (or is coupled to) network interface(s) 327 that provides network connectivity to support functionality such as over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), automated calling functionality, etc.

In many embodiments, control system 104 also includes, inter alia, Autonomy Control Module (ACM) ECU, Autonomous Safety Module (ASM) ECU, Body Control Module (BCM) ECU, Battery Management System (BMS) ECU, Battery Power Isolation (BPI) ECU, Balancing Voltage Temperature (BVT) ECU, Door Control Module (DCM) ECU, Driver Monitoring System (DMS) ECU, Near-Field Communication (NFC) ECU, Rear Zone Control (RZC) ECU, Seat Control Module (SCM) ECU, Thermal Management Module (TMM) ECU, Vehicle Access System (VAS) ECU, Vehicle Dynamics Module (VDM) ECU, Winch Control Module (WCM) ECU, an Experience Management Module (XMM) ECU, etc. In certain embodiments, the XMM ECU may transmit data to the TCM ECU 326 via Ethernet. Additionally or alternatively, the XMM ECU may transmit other data (e.g., sound data from microphones 311, etc.) to the TCM ECU 326.

In an illustrative example, TMM ECU 329 can control operations of cabin system 105. In some embodiments, TMM ECU 329 may be configured to generate control signals, receive sensor signals, implement and update an algorithm (e.g., manage a state machine, state-flow system, logic instructions, or other suitable algorithm or combination thereof), update setpoints or targets, measure or determine vehicle operating information (e.g., measured or estimated temperatures, heat transfer, humidity psychometrics, or any other suitable information), receive information (e.g., from a remote system), retrieve reference information, determine a response, perform any other operation, or any combination thereof.

In some embodiments, TMM ECU 329 is configured to store information for managing climate conditions and optimizing cabin comfort. In some embodiments, TMM ECU 329, BCM ECU 328, or another of the ECUs 330 is configured to generate a display at any of the user interfaces 315, for example, to show the occupant available adjustments, system performance, current conditions (e.g., temperature, fogging metric), target conditions, reference values (e.g., predetermined limits, saturations, or thresholds), any other suitable information, or any combination thereof. In an illustrative example, suitable components of cabin system 105 may be configured to operate based on respective setpoints, and TMM ECU 329, BCM ECU 328 and/or another of the ECUs 330 is configured to modify the setpoints to manage comfort.

In some embodiments, TMM ECU 329 is configured to control cabin system 105 to provide occupant comfort, interior environment control, or otherwise affect cabin climate conditions. In an illustrative example, TMM ECU 329 can be configured to modify or cease modifying at least one cabin climate setting such as air-conditioning (AC) setpoint (e.g., based on compressor speed), blower fan setpoint (e.g., a speed of a blower motor), heating temperature setpoint (e.g., as achieved by controlling current flow across a resistive element), total heating or cooling rate, duration of heating or cooling, climate-controlled surface setting (e.g., degree of heating or cooling) or a combination thereof. In some embodiments, TMM ECU 329, for example, is configured to increase or decrease an AC setpoint for a desired control circuitry comfort level, turn surface (e.g., seat and/or steering wheel) heating and cooling ON or OFF, adjust airflow rate, adjust discharge or vent air temperature, or otherwise affect climate conditions in vehicle interior 102.

In certain embodiments, TMM ECU 329 and/or another of the ECUs 330 can personalize climate conditions in vehicle 100 based on a physiological status of an occupant in vehicle interior 102. The physiological status can be, or include, a biometric such as heart rate or body temperature, an identification of a recently completed activity such as running or swimming (e.g., an activity of the occupant within a specified preceding time period such as one hour), and/or other information related to the occupant's physical or biological need for thermal comfort. Although, in various embodiments, TMM ECU 329 may consider physiological statuses of a plurality of occupants, for simplicity of description, personalization will be described relative to a single occupant.

In certain embodiments, TMM ECU 329, or another of the ECUs 330, can determine the physiological status of the occupant in various fashions. In an example, TMM ECU 329, or another of the ECUs 330, can determine the physiological status of the occupant based on data provided, or made available by, one or more of the user devices 318 that may be associated with the occupant. User devices 318 may include, for example, a smartphone, a wearable such as a smartwatch and/or fitness tracker, and/or another computer or mobile device that may accompany the occupant. In various examples, user devices 318 can be configured to supply, for example, via I/O interfaces 323, a biometric such as heart rate or body temperature, an identification of completed activities in relation to a time of completion (e.g., completed workouts), activity scheduling information (e.g., swimming from 5-6 pm on Mondays and Wednesdays), and/or the like. In some embodiments, user devices 318 can supply any of the foregoing data at regular intervals, on demand when requested by one of the ECUs 330, etc.

In another example, TMM ECU 329 or another of the ECUs 330 can determine the physiological status based, at least in part, on a location of vehicle 100. The location of vehicle 100 can be determined in various fashions. In some embodiments, the location can be determined from information provided by location system 314 (e.g., via GPS data as described previously). In another example, the location of vehicle 100 can be determined, at least in part, based on data provided, or made available by, one or more of the user devices 318 that may be associated with the occupant. For example, user devices 318 can be configured to supply, for example, via I/O interfaces 323, calendar or scheduling information that indicates a time and location (e.g., Grand Country Club from 3-4 pm).

TMM ECU 329 or another of the ECUs 330 can infer (e.g., predict) an activity of the occupant within a specified preceding time period, such as one hour, based on the location of the vehicle within that specified preceding time period. For example, if the location is a country club, golf may be inferred. In another example, if the location is a swim club, swimming may be inferred. As another example, if the location is a beach, surfing may be inferred. By way of further example, if the location of is a basketball or tennis court, basketball or tennis, respectively, may be inferred. Other examples will be apparent to one skilled in the art after a detailed review of the present disclosure.

In still another example, TMM ECU 329 or another of the ECUs 330 can determine the physiological status of the occupant based on an indication, by the occupant, via any of user interfaces 315. The indication can be, for example, an identification, by the occupant, of an activity recently completed (e.g., running, swimming, or surfing). In addition, or alternatively, the indication can be, for example, an input or entry, by the occupant, of a biometric such as heart rate or body temperature. In still another example, TMM ECU 329 or another of the ECUs 330 can determine the physiological status based on receipt of any of the foregoing data from a network service, such as a cloud service communicably accessible to vehicle 100 and/or any of the user devices 318.

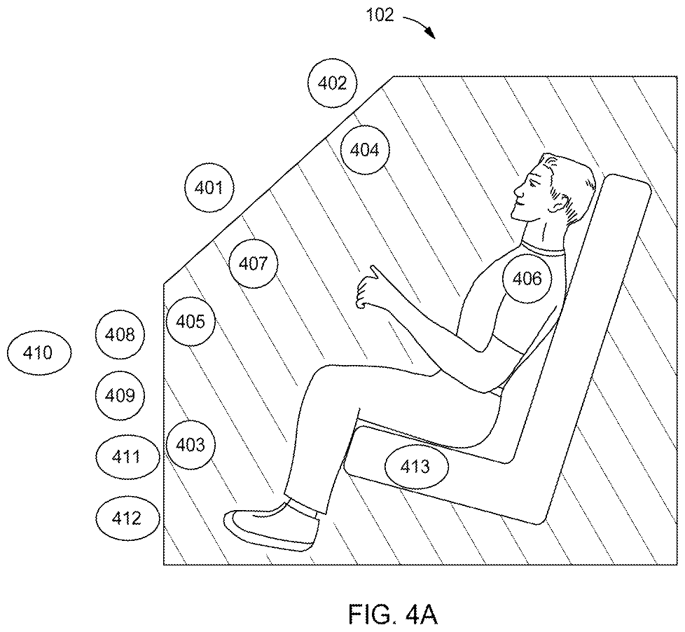

In certain embodiments, TMM ECU 329 can determine a climate control response based on the physiological status of the occupant. For example, if the occupant has been running and/or has an elevated heart rate (e.g., over 100 beats per minute), a more aggressive response (e.g., a more aggressive cooling response) may be warranted. Conversely, if the occupant has been swimming, such that it may be inferred that the occupant is wet, a different response (e.g., a less aggressive cooling response or a heating response) may be warranted. In various cases, TMM ECU 329 can control cabin system 105 in any of the ways described previously based on the determined response. It should be appreciated that the climate control response can be similarly varied according to any other activity such as tennis, basketball, or the like. Examples will be described in greater detail relative to FIGS. 4A-B and 5-7.

FIGS. 4A-B illustrate example functionality to personalize climate conditions in vehicle 100, in accordance with certain embodiments of the present disclosure. In particular, FIG. 4A illustrates an example of a side view of vehicle interior 102 of FIG. 1, with corresponding inputs and outputs for control system 104, in accordance with certain embodiments of the present disclosure. FIG. 4B illustrates an example of an operational flow 400 to personalize climate conditions, in accordance with certain embodiments of the present disclosure.

Referring to FIGS. 4A-B collectively, the operational flow 400 can be executed by control system 104 described relative to FIGS. 1-3. In general, the operational flow 400 can include receiving or determining inputs 481, processing the inputs 481 using a model 485, and generating target outputs 490. Inputs 481 can include, for example, vehicle signals 482, physiological signals 483, user climate inputs 484, and/or any other suitable data or information.

With particular reference to the inputs 481, the vehicle signals 482 can include, for example, an ambient temperature 401 (e.g., a windshield temperature), a solar flux 402 (e.g., irradiation in a suitable spectral range), a cabin temperature 403, a cabin relative humidity 404, and a vent air temperature 405. In various embodiments, the ambient temperature 401, the solar flux 402, the cabin temperature 403, and the cabin relative humidity 404 can be supplied, for example, by the ambient temperature sensor 252, the solar flux sensor 253, the cabin temperature sensor 254 and the cabin relative humidity sensor 255, respectively, of the sensor system 251 described relative to FIG. 2. The vent air temperature 405 can be, for example, feedback from previous execution of the operational flow 400 (e.g., corresponding to discharge or vent air temperatures 409 discussed below), or an estimation from other sensors within the cabin system 105 (e.g., within the sensor system 251).

Still with reference to the inputs 481, the physiological signals 483 can include any data usable to determine a physiological status of the occupant as described relative to FIG. 3. For example, the physiological signals 483 can be, or include, user device data 406 that is provided, or made available by, one or more of the user devices 318 as described relative to FIG. 3. In addition, or alternatively, the physiological signals 483 can be, or include, an indication, by the occupant, via any of user interfaces 315 as described relative to FIG. 3. In addition, or alternatively, the physiological signals 483 can be, or include, data from a network service, such as a cloud service communicably accessible to vehicle 100 and/or any of the user devices 318 as described relative to FIG. 3. In various embodiments, the user climate inputs 484 can include, for example, commands provided by the occupant, such as a user setpoint temperature 407. The user climate inputs 484 can be received, for example, via any of the user interfaces 315 of FIG. 3.

In general, the target outputs 490 correspond to a climate control response to the inputs 491. The target outputs 490 can include, for example, vent airflow rates 408, sometimes referred to as cabin flow rates (e.g., adjustable by a speed of blower 261 of FIG. 2), discharge or vent air temperatures 409 (e.g., temperature of air leaving cabin system 105), a compressor speed 410 (e.g., speed of compressor 271 of FIG. 2), HVAC door positions 411 (e.g., positions of duct doors 262 of FIG. 2), local vent positions 412 (e.g., positions of vents through which air enters vehicle interior 102), and climate-controlled surface settings 413 (e.g., degree of heating or cooling being provided on surfaces of climate-controlled surfaces system 280).

In general, the model 485 can represent any suitable logic for generating target values 488 based on the inputs 481 or a subset thereof. In some cases, the target values 488 are the same as the target outputs 490. In other cases, the target values 488 are not necessarily the same as the target outputs 490 but may be mapped to the target outputs 490 in a deterministic fashion (e.g., including translation or transformation of the target values 488 to control signals, commands, or the like). For example, the target values 488 can include a target heat removal (Q), a target airflow rate, a target cabin temperature (T), and/or other values. According to this example, the target airflow rate and the target cabin temperature (T) can map, for example, to the vent airflow rates 408 and the vent air temperatures 409.

In some embodiments, the model 485 can be at least partially rules-based. For example, the model 485 can establish certain response categories, such as aggressive, intermediate, or mild. In these embodiments, each category can associate, for example, defined values or ranges of values for the inputs 481 with a combination of settings corresponding to the target values 488. In one example, the response categories can be established in terms of heart rate, such that under 100 beats per minute is associated with a mild response, 100 to 120 beats per minute is associated with an intermediate response, and over 120 beats per minute is associated with an aggressive response.

In another example, particular activities within a specified preceding time period, such as one hour, can be associated with particular categories of responses (e.g., running within the preceding one hour can be associated with an aggressive response). Other examples will be apparent to one skilled in the art after detailed review of the present disclosure. The response categories can be stored, for example, in memory 334 of the TMM ECU 329 or another of the ECUs 330. According to this example, as the inputs 481 are received or determined, the control system 104 can map the inputs 481 to a response category and thereby determine the target values 488.

In some embodiments, the model 485 can be at least partially based in machine learning (e.g., supervised learning). For example, the model 485 can be trained on datasets for a large set of users. According to this example, the datasets on which the model 485 is trained can include records detailing sets of features such as physiological statuses (e.g., biometrics, identification of activities, etc.), vehicle signals similar to the vehicle signals 482, and/or information describing each user or occupant (e.g., age, gender, and ethnicity). Each record can further include, or be labeled with, optimal target values given the features of the record, where the optimal target values may correspond to user climate input, user-validated values, or the like. Therefore, according to this example, the control system 104 can use the occupant's physiological status, the vehicle signals 482, and/or available information describing the occupant (e.g., age, gender, ethnicity, etc.) to determine the target values 488 based on the model 485.

In addition, or alternatively, the model 485 can be trained or tuned specifically for vehicle 100 and/or any occupant thereof. For example, control system 104 can treat the user climate inputs 484 as feedback to learn user preferences for the target values 488 given particular combinations of the inputs 481, and then update the model 485. In various embodiments, over time, the model 485 can thereby adapt and become increasingly customized to vehicle 100 and/or personalized to an occupant thereof.

In another example, in some embodiments, the datasets on which the model 485 is trained can include records detailing sets of features such as vehicle locations, times, and information describing each user or occupant (e.g., age, gender, and ethnicity), so as to enable predictions or inferences of physiological status. Each record can further include, or be labeled with, physiological statuses, such as an identification of an activity, or the like. Therefore, according to this example, the control system 104 can use the vehicle locations, times, and/or other available information to determine the physiological status on which climate control is based.

In some embodiments, as illustrated in the example of FIG. 4B, the model 485 can include a combination of models such as a cabin model 486 and an occupant model 487. According to this example, the cabin model 486 can include, for example, physics-based logic for determining the target values 488, such as any rules-based and/or machine learning model as described previously. In certain embodiments, the cabin model 486 may exclude consideration of the physiological signals 483, whereas the occupant model 487 may consider the physiological signals 483 as well as others of the inputs 481. Continuing this example, control system 104 can use the cabin model 486 to determine baseline target values, and then use the occupant model 487 to generate offset values that represent adjustments to the baseline target values due to the physiological status of the occupant. According to this example, the target values 488 can thereby represent a combination of the baseline target values and the offset values. In some embodiments, utilization of the occupant model 487 can be selectively enabled or disabled, for example, via the user interfaces 315 of FIG. 3.

In various embodiments, the occupant model 487 can associate distinct physiological statuses with distinct metabolic heat generation at the body and its distribution between upper and lower body portions. In certain embodiments, the association of the physiological statuses with heat generation and distribution enables offset values that correspondingly distribute air temperature and airflow rate to maximize local thermal comfort. For example, if the occupant has recently finished swimming, their metabolic rate may be high but their body may be cold. According to this example, if a given physiological status identifies swimming, there may be a need to increase air temperature for the occupant's lower body, where relative heating may be desirable, as compared to the occupant's upper body, where relative cooling may be desirable.

In certain embodiments, the occupant's physiological status thus provides, or may be associated with, an overview of heat distribution over the body of the occupant. The model 485, via the cabin model 486 and the occupant model 487, can thereby correlate the occupant's physiological status to various local targets such as airflow rate and temperature. For example, the heat distribution can correlate to an airflow rate and an air temperature at each vent in the vehicle 100, or at each divisible set of vents in the vehicle 100. The airflow rate and/or air temperature can differ for each vent (or for each divisible set of vents) based on the vent's spatial position relative to the occupant and/or the vent's spatial position relative to the heat distribution over the body of the occupant (e.g., relative position to an upper or lower body of the occupant as described above relative to swimming). A combination of multiple vent airflow rates and temperatures, among values, can be included in the target values 488, which values can then be translated to actuatable commands in the form of the target outputs 490 (e.g., the vent airflow rates 408 and the vent air temperatures 409).

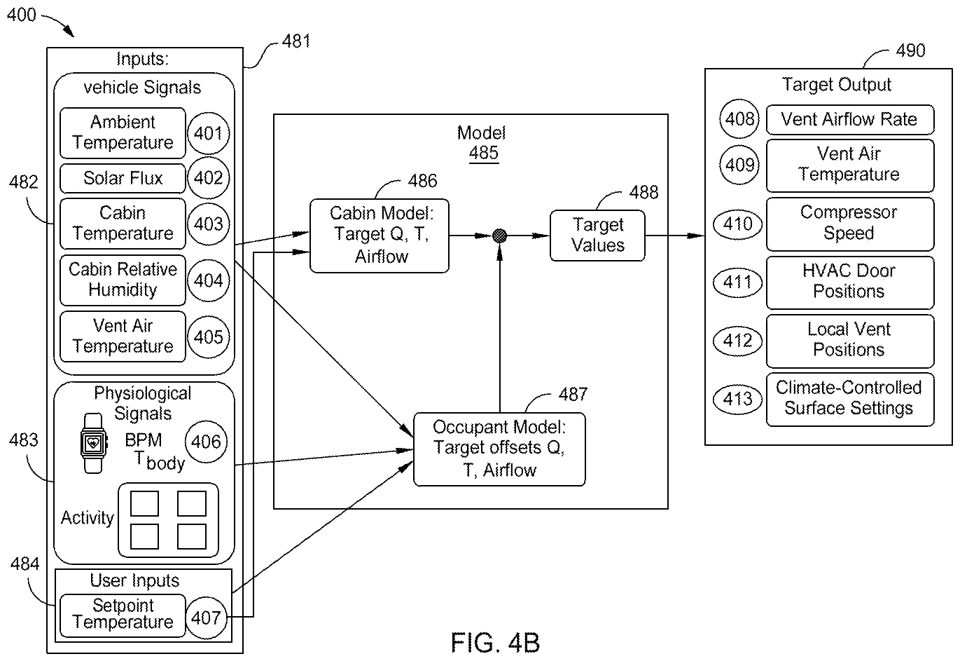

FIG. 5 illustrates an example of a process 500 for personalizing climate conditions in a vehicle such as vehicle 100 of FIG. 1, in accordance with certain embodiments of the present disclosure. In certain embodiments, the process 500 can be implemented by any vehicle system that can process data. Although any number of systems, in whole or in part, can implement the process 500, to simplify discussion, the process 500 will be described in relation to control system 104 of vehicle 100 as described relative to FIGS. 1-3 and 4A-B.

At block 502, the control system 104 receives inputs such as, for example, the inputs 481 of FIGS. 4A-B. At block 504, the control system 104 determines a physiological status of an occupant of vehicle 100. In general, the physiological status can be determined in any of the ways described relative to FIGS. 3 and 4A-B, such as from the physiological signals 483 of FIG. 4B. For example, the block 504 can involve the control system 104 determining, from the physiological signals 483, a biometric of the occupant, such as a body temperature or heart rate. In addition, or alternatively, the block 504 can involve the control system 104 identifying (e.g., inferring or predicting) an activity of the occupant (e.g., running, swimming, or surfing) within a specified preceding time period, such as one hour, based on a location of vehicle 100 and/or historical activity information associated with the occupant or other users at the location as described relative to FIGS. 3 and 4A-B.

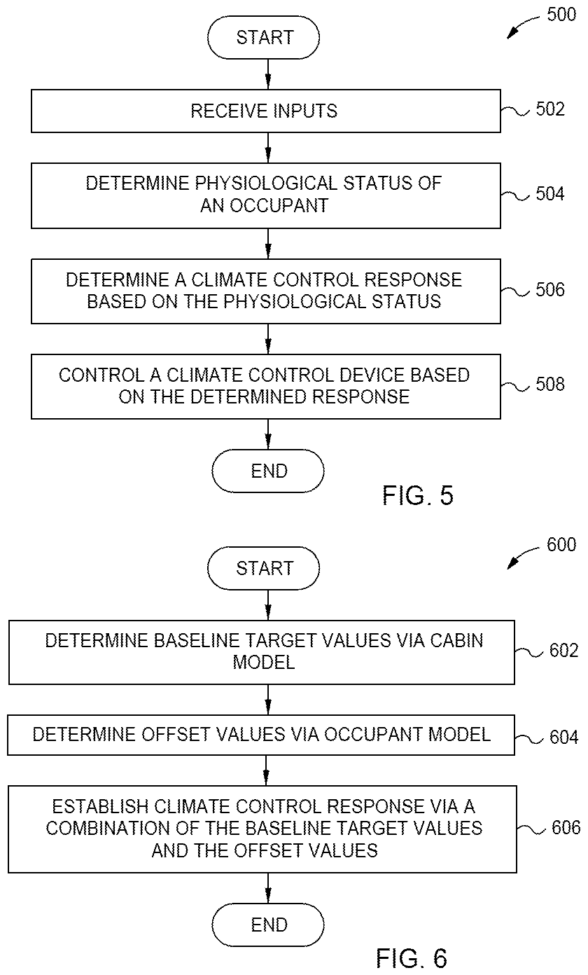

At block 506, the control system 104 determines a climate control response based on the physiological status of the occupant and/or any of the inputs 481 of FIGS. 4A-B. The block 506 can include, for example, generating the target outputs 490 based on the model 485 as described relative to FIGS. 4A-B. The climate control response can include, for example, a vent airflow rate, a discharge or vent air temperature, a compressor speed, an air system duct door position, a vent position, a climate-controlled surface setting, multiple of the foregoing, combinations of the foregoing and/or the like. In some embodiments, the climate control response can be based on a heat distribution over a body of the occupant. For example, as described relative to FIG. 4, in some cases, the climate control response can include different target outputs for different vents of the vehicle 100 based on spatial positions of the vents relative to the heat distribution over the body of the occupant. An example of determining a climate control response using the model 485 of FIG. 4 will be described in greater detail relative to FIG. 6.

At block 508, the control system 104 controls a climate control device based on the climate control response determined at the block 506. For example, the control system 104 can send one or more control signals, or commands, to the cabin system 105 and/or components thereof. In a typical embodiment, the control signals, or commands, cause the cabin system 105 and/or its components to implement the climate control response. After block 508, the process 500 ends.

FIG. 6 illustrates an example of a process 600 for determining a climate control response, in accordance with certain embodiments of the present disclosure. In certain embodiments, the process 600 can be performed as all or part of the block 506 of FIG. 5. In certain embodiments, the process 600 can be implemented by any vehicle system that can process data. Although any number of systems, in whole or in part, can implement the process 600, to simplify discussion, the process 600 will be described in relation to control system 104 of vehicle 100 as described relative to FIGS. 1-3 and 4A-B.

At block 602, the control system 104 determines one or more baseline target values via the cabin model 486 of FIG. 4B. In various embodiments, the baseline target values can be based on the vehicle signals 482 and/or the user climate inputs 484. The baseline target values can include, for example, a target heat removal (Q), a target airflow rate, a target cabin temperature (T), and/or other values.

At block 604, the control system 104 determines offset values via the occupant model 487 of FIG. 4B. The offset values can represent adjustments to the baseline target values (e.g., adjustments up or down), for example, based on the physiological status of the occupant.

At block 606, the control system 104 establishes the climate control response using a combination of the baseline target values and the offset values. For example, as described with reference to FIG. 4B, the target values 488 can reflect the baseline target values as adjusted by the offset values. According to this example, the climate control response, as represented by the target outputs 490, is thus based on the combination of the baseline target values resultant from the cabin model 486 and the offset values resultant from the occupant model 487. After block 606, the process 600 ends.

The many features and advantages of the disclosure are apparent from the detailed specification, and, thus, it is intended by the appended claims to cover all such features and advantages of the disclosure which fall within the scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A method of personalizing climate conditions in a vehicle, the method comprising:
determining, by a vehicle control system, a physiological status of an occupant of the vehicle;
determining, by the vehicle control system, a climate control response based on the physiological status of the occupant; and
controlling at least one climate control device in relation to an interior of the vehicle based on the climate control response.

2. The method of claim 1, wherein the determining a physiological status comprises determining a biometric of the occupant.

3. The method of claim 2, wherein the biometric comprises at least one of a body temperature or a heart rate of the occupant.

4. The method of claim 1, wherein the determining a physiological status comprises identifying an activity of the occupant within a specified preceding time period.

5. The method of claim 1, wherein the climate control response comprises at least one of an airflow rate, a vent air temperature, a compressor speed, an air system duct door position, a vent position, or a climate-controlled surface setting.

6. The method of claim 1, further comprising receiving one or more inputs from one or more vehicle sensors, wherein the determining a climate control response is further based on the one or more inputs.

7. The method of claim 6, wherein the one or more inputs comprise at least one of ambient temperature, solar flux, cabin temperature, cabin relative humidity, or vent air temperature.

8. The method of claim 6, further comprising receiving a user setpoint temperature, wherein the determining a climate control response is further based on the user setpoint temperature.

9. The method of claim 6, wherein the determining a climate control response comprises:
via a first model, determining a first value based on the one or more inputs from the one or more vehicle sensors;
via a second model, determining a second value based on the one or more inputs from the one or more vehicle sensors and the physiological status of the occupant; and
establishing the climate control response via a combination of the first value and the second value.

10. The method of claim 9, wherein the second value is an adjustment to the first value.

11. The method of claim 1, wherein the physiological status is associated with a heat distribution over a body of the occupant and the climate control response is determined based on the heat distribution.

12. The method of claim 11, wherein the climate control response comprises different target outputs for first and second vents of the vehicle based on spatial positions of the first and second vents relative to the heat distribution over the body of the occupant.

13. A system for personalizing climate conditions in a vehicle, the system comprising:
at least one climate control device;
a vehicle control system communicably coupled to the at least one climate control device and operable to:
determine a physiological status of an occupant of the vehicle;
determine a climate control response based on the physiological status of the occupant; and
control the at least one climate control device in relation to an interior of the vehicle based on the climate control response.

14. The system of claim 13, wherein the operability to determine a physiological status comprises operability to determine a biometric of the occupant.

15. The system of claim 14, wherein the biometric comprises at least one of a body temperature or a heart rate of the occupant.

16. The system of claim 13, wherein the operability to determine a physiological status comprises operability to identify an activity of the occupant within a specified preceding time period.

17. The system of claim 13, wherein the climate control response comprises at least one of an airflow rate, a vent air temperature, a compressor speed, an air system duct door position, a vent position, or a climate-controlled surface setting.

18. The system of claim 13, wherein the vehicle control system is further operable to receive one or more inputs from one or more vehicle sensors, and wherein the climate control response is further based on the one or more inputs.

19. The system of claim 18, wherein the operability to determine a climate control response comprises operability to:
determine, via a first model, a first value based on the one or more inputs from the one or more vehicle sensors;
determine, via a second model, a second value based on the one or more inputs from the one or more vehicle sensors and the physiological status of the occupant; and
establish the climate control response via a combination of the first value and the second value.

20. The system of claim 19, wherein the second value is an adjustment to the first value.
